(19) United States
(12) Patent Application Publication
(10) Pub. No.: US 2009/0033473 A1
(43) Pub. Date: Feb. 5, 2009

(54) Piezoelectric buzzer

(75) Inventors: Cheng-Sheng Yu, Kaohsiung City (TW); Huey-Lin Hsieh, Yung-Kang City (TW); Tsai-Kun Huang, Ping-Tung City (TW); Jyh-Jang Wey, Min-Hsiung Hsiang (TW); Wu-Song Chuang, Ying-Ko Chen (TW); Chun-Jung Lin, Taoyuan City (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: CHINA STEEL CORPORATION, Kaohsiung City (TW)

(21) Appl. No.: 11/882,413

(22) Filed: Aug. 1, 2007

(51) Int. Cl. G08B 3/10

(52) U.S. Cl. 340/384.6

(57) ABSTRACT

A piezoelectric buzzer includes a housing unit, a buzzer unit, and first and second terminals. The housing unit includes first and second housings coupled together. The second housing includes a base plate and a pair of spaced apart insert seats, each of which protrudes inwardly from the base plate toward the first housing and is formed with an insert hole. The buzzer unit is disposed in the resonant chamber and includes a vibrating plate and a piezoelectric plate attached to the vibrating plate. The first and second terminals are inserted respectively into the insert holes of the insert seats, and have a respective connection section extending outwardly of the housing unit, and a respective extending section abutting against a respective one of the vibrating plate and the piezoelectric plate.

### BACKGROUND OF THE INVENTION

1. Field of the Invention

The invention relates to a buzzer, more particularly to a piezoelectric buzzer.

2. Description of the Related Art

As shown in FIGS. 1 and 2, a conventional piezoelectric buzzer 1 includes a first housing 11, a second housing 12 coupled to the first housing 11 and cooperating with the first housing 11 to define a resonant chamber 10, a buzzer unit 13 disposed in the resonant chamber 10, and conductive first and second terminals 14, 15.

The second housing 12 includes a base plate 121 and a pair of spaced apart insert seats 122, each of which protrudes outwardly from the base plate 121 and is formed with an insert hole 123. The buzzer unit 13 includes a metallic vibrating plate 131, and a piezoelectric plate 132 made from ceramic material and attached to the vibrating plate 131.

Each of the first and second terminals 14, 15 is inserted into the insert hole 123 in a respective one of the insert seats 122 of the second housing 12. The first terminal 14 has a first connection section 141 extending outwardly of the resonant chamber 10, a first extending section 142 extending from the first connection section 141 into the resonant chamber 10 and extending toward the buzzer unit 13, and a first contact point 143 spot-welded to one end of the first extending section 142 and contacting electrically the vibrating plate 131 of the buzzer unit 13. The second terminal 15 has a second connection section 151 extending outwardly of the resonant chamber 10, a second extending section 152 extending from the second connection section 151 into the resonant chamber 10 and extending toward the buzzer unit 13, and a second contact point 153 spot-welded to one end of the second extending section 152 and contacting electrically the piezoelectric plate 132 of the buzzer unit 13. Application of an alternating current voltage to the vibrating plate 131 and the piezoelectric plate 132 via the first and second connection sections 141, 151 will cause mechanical distortion of the vibrating plate 131 due to the piezoelectric effect, thereby generating sounds.

To firmly position the first and second terminals 14, 15, the insert seats 122 of the second housing 12 are disposed to protrude outwardly from the base plate 121 of the second housing 12 for making the insert holes 123 deeper. However, the outwardly protruding insert seats 122 result in a relatively thick piezoelectric buzzer. The thickness of the conventional piezoelectric buzzer is 6.8 millimeters measured from the first housing 11 to the base plate 121 of the second housing 12, which hinders application to some electronic devices, such as on-board units (OBU) for Electronic Toll Collection (ETC) system (the maximum standard thickness being 6.2 millimeters). Moreover, the relatively large distances between each of the first and second connection sections 141, 151 and the buzzer unit 3 weaken the resilient contact forces of the first and second extending sections 142, 152 for abutting respectively against the vibrating plate 131 and the piezoelectric plate 132, thereby resulting in poor contact quality therebetween. Furthermore, the spot-welding of the first and second contact points 143, 153 results in a relatively complicated and time-consuming manufacturing process for the piezoelectric buzzer.

### SUMMARY OF THE INVENTION

Therefore, the object of the present invention is to provide a piezoelectric buzzer with a smaller size, a simpler manufacturing process, and better contact quality between the terminals and the buzzer unit.

Accordingly, a piezoelectric buzzer of the present invention comprises a housing unit, a buzzer unit, and first and second terminals. The housing unit includes a first housing, and a second housing that is coupled to the first housing and that cooperates with the first housing to define a resonant chamber. The second housing includes a base plate and a pair of spaced apart insert seats, each of which protrudes inwardly from the base plate toward the first housing and is formed with an insert hole. The buzzer unit is disposed in the resonant chamber and includes a vibrating plate and a piezoelectric plate attached to the vibrating plate. The first terminal is inserted into the insert hole in one of the insert seats of the second housing, and has a first connection section that extends outwardly of the resonant chamber, and a first extending section that extends from first connection section into the resonant chamber and that abuts against the vibrating plate of the buzzer unit. The second terminal is inserted into the insert hole in the other one of the insert seats of the second housing, and has a second connection section that extends outwardly of the resonant chamber, and a second extending section that extends from the second connection section into the resonant chamber and that abuts against the piezoelectric plate of the buzzer unit.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional piezoelectric buzzer;

FIG. 2 is a partly sectional view of the conventional piezoelectric buzzer;

FIG. 3 is an exploded perspective view of a preferred embodiment of a piezoelectric buzzer according to the invention;

FIG. 4 is a partly sectional view of the preferred embodiment; and

FIG. 5 is a graph illustrating measurement results of the preferred embodiment for sound pressure levels in a frequency range between 500 Hz and 10 kHz.

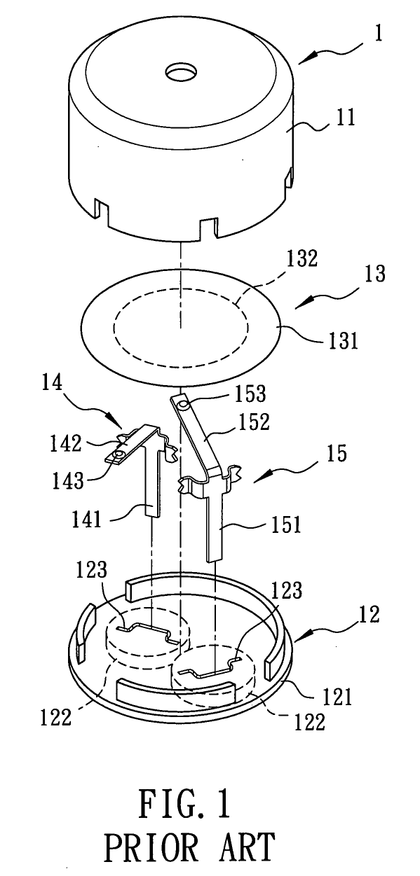

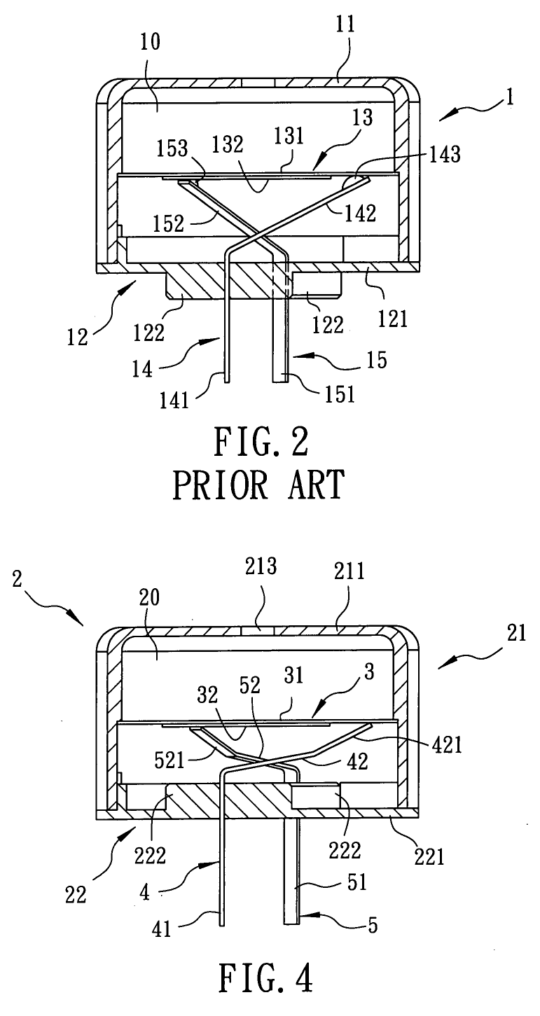

### DETAILED DESCRIPTION OF THE PREFERRED EMBODIMENT

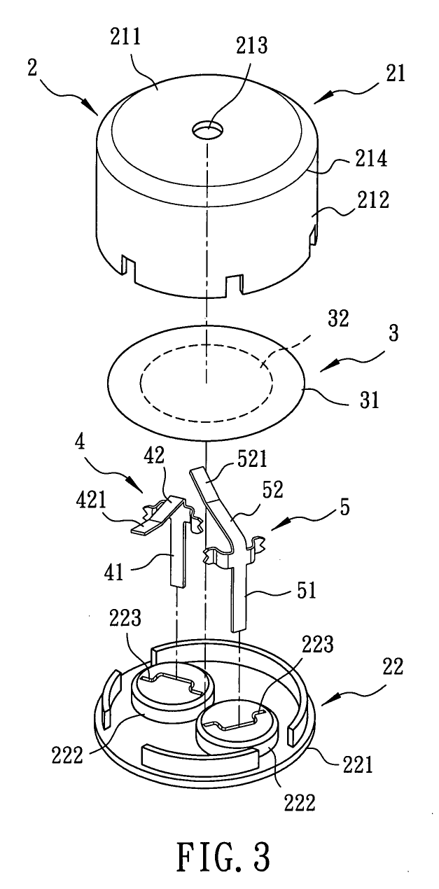

As shown in FIGS. 3 and 4, the preferred embodiment of a piezoelectric buzzer according to the present invention is adapted for use with an OBU for ETC system, and comprises a housing unit 2, a buzzer unit 3, and first and second terminals 4, 5.

The housing 2 includes a first housing 21, and a second housing 22 that is coupled to the first housing 21 and that cooperates with the first housing 21 to define a resonant chamber 20. The first housing 21 includes a base wall 211 having a wall periphery 214 and formed with a sound outlet 213, and a surrounding wall 212 extending from the wall periphery 214 of the base wall 211 toward the second housing 22 and coupled to the second housing 22. The second housing 22 includes a base plate 221 and a pair of spaced apart insert seats 222, each of which protrudes inwardly from the base plate 221 toward the first housing 21 and is formed with an insert hole 223.

The buzzer unit 3 is disposed in the resonant chamber 20 and includes a vibrating plate 31 and a piezoelectric plate 32 attached to the vibrating plate 31. In this embodiment, the vibrating plate 31 is made from iron-nickel (Fe—Ni) alloy, and the piezoelectric plate 32 is made from ceramic material that has a dielectric constant of 4000.

The first terminal 4 is inserted into the insert hole 223 in one of the insert seats 222 of the second housing 22 of the housing unit 2, and has a first connection section 41 that extends outwardly of the resonant chamber 20, and a first extending section 42 that extends from the first connection section 41 into the resonant chamber 20 and that abuts against the vibrating plate 31 of the buzzer unit 3. The second terminal 5 is inserted into the insert hole 223 in the other one of the insert seats 222 of the second housing 22, and has a second connection section 51 that extends outwardly of the resonant chamber 20, and a second extending section 52 that extends from the second connection section 51 into the resonant chamber 20 and that abuts against the piezoelectric plate 32 of the buzzer unit 3. In this embodiment, the first extending section 42 has a first bent end segment 421 bent toward the buzzer unit 3, and the second extending section 52 has a second bent end segment 521 bent toward the buzzer unit 3.

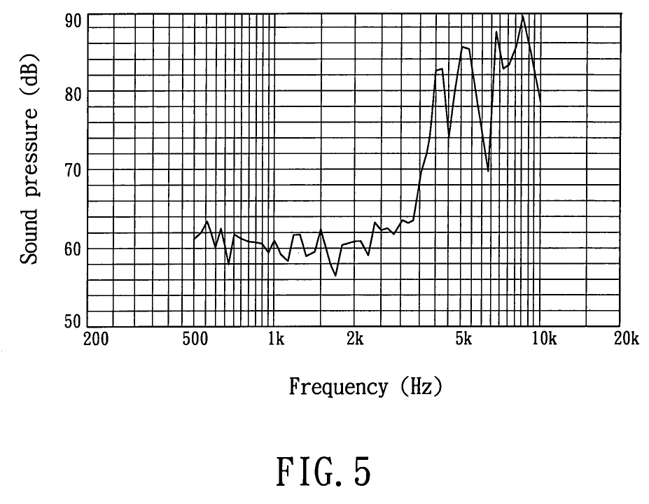

As shown in FIGS. 4 and 5, the housing unit 2 has a thickness of 6.2 millimeters measured from the base wall 211 of the first housing 21 to the base plate 221 of the second housing 22, which conforms to the standard for an OBU. Moreover, under a drive power of 3 Vrms, the piezoelectric buzzer has sound pressure levels of 83 dB at a frequency of 4000 Hz, and 82.6 dB at a frequency of 5300 Hz, both exceeding the minimum standard of 80 dB.

Compared to the insert seats 122 of the prior art, the insert seats 222 of the second housing 22 of the housing unit 2 that protrude inwardly from the second housing 22 toward the first housing 21 of the housing unit 2 effectively reduce the thickness of the piezoelectric buzzer. After inserting each of the first and second terminals 4, 5 into the insert hole 223 of a respective one of the insert seats 222, the distance between each of the first and second connection sections 41, 51 and the buzzer unit 3 is also shorter than that of the prior art, thereby strengthening the resilient contact forces of the first and second extending sections 42, 52 for abutting respectively and firmly against the vibrating plate 31 and the piezoelectric plate 32. Furthermore, compared to the first and second contact points 143, 153 of the prior art, the first and second bent end segments 421, 521 not only contact the buzzer unit 3 more firmly, but also result in a simpler manufacturing process.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A piezoelectric buzzer comprising:
a housing unit including a first housing, and a second housing that is coupled to said first housing and that cooperates with said first housing to define a resonant chamber, said second housing including a base plate and a pair of spaced apart insert seats, each of which protrudes inwardly from said base plate toward said first housing and is formed with an insert hole;
a buzzer unit disposed in said resonant chamber and including a vibrating plate and a piezoelectric plate attached to said vibrating plate;
a first terminal inserted into said insert hole in one of said insert seats of said second housing, and having a first connection section that extends outwardly of said resonant chamber, and a first extending section that extends from first connection section into said resonant chamber and that abuts against said vibrating plate of said buzzer unit; and
a second terminal inserted into said insert hole in the other one of said insert seats of said second housing, and having a second connection section that extends outwardly of said resonant chamber, and a second extending section that extends from said second connection section into said resonant chamber and that abuts against said piezoelectric plate of said buzzer unit.

2. The piezoelectric buzzer as claimed in claim 1, wherein each of said first extending section of said first terminal and said second extending section of said second terminal has a bent end segment bent toward said buzzer unit.

3. The piezoelectric buzzer as claimed in claim 2, wherein said first housing of said housing unit includes a base wall having a wall periphery and formed with a sound outlet, and a surrounding wall extending from said wall periphery of said base wall toward said second housing and coupled to said second housing.

4. The piezoelectric buzzer as claimed in claim 3, wherein said vibrating plate of said buzzer unit is made from iron-nickel alloy, said piezoelectric plate being made from ceramic material that has a dielectric constant of 4000.

5. The piezoelectric buzzer as claimed in claim 3, wherein said housing unit has a thickness not greater than 6.2 millimeters measured from said base wall of said first housing to said base plate of said second housing.
